(19) United States
(12) Patent Application Publication
(10) Pub. No.: US 2003/0183058 A1
(43) Pub. Date: Oct. 2, 2003

(54) Cutting apparatus capable of imparting curved edge to paper

(75) Inventors: Yu-Shuo Fan, Taipei (TW); Kris Gustaaf Marguerite Verstockt, Taipei (TW); Tzu-Feng Tseng, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Primax Electronics Ltd., Taipei (TW)

(21) Appl. No.: 10/244,919

(22) Filed: Sep. 16, 2002

(30) Foreign Application Priority Data
Mar. 28, 2002 (TW) 091106200

(51) Int. Cl. B26D 7/02; B26D 5/08

(52) U.S. Cl. 83/455; 83/614

(57) ABSTRACT

A cutting apparatus providing a flat material with a curved edge is disclosed. The cutting apparatus includes a main body, a center member and an arm. The center member is mounted to the main body. The arm engages with the center member and has a cutting part thereon. The cutting part cuts the flat material to have the curved edge by rotating the arm about the center member.

### FIELD OF THE INVENTION

The present invention relates to a cutting apparatus, and more particularly, the present invention relates to a two dimensional cutting apparatus for cutting a flat material such as paper to impart the cut paper various shapes.

### BACKGROUND OF THE INVENTION

Nowadays, people need to use various apparatus to accomplish different works. For example, people use a cutting apparatus to cut paper into small sheets neatly and conveniently. Referring to FIG. 1, a conventional cutting apparatus is depicted. The cutting apparatus 10 includes a rail 11 and a slider 12. The rail 11 has a passage 111 thereunder for receiving a flat material (not shown) such as paper. The slider 12 movable along the rail 11 is depicted in FIG. 2. The slider 12 includes a cutting part 121 in the bottom thereof, which is pressed downwards to reach and cut paper while the slider 12 is moving along the rail 11.

Apparently, the cutting apparatus can cut paper in one dimension only under the guidance of the linear rail. For some cases that a curved edge is required, the conventional cutting apparatus helps little. So far, a cutting apparatus that can cut paper to have a curved edge is still unavailable. Therefore, it is necessary to develop such a cutting apparatus.

### SUMMARY OF THE INVENTION

Therefore, an object of the present invention is to provide a cutting apparatus that is capable of creating a curved edge for the cut material.

Another object of the present invention is to provide a cutting apparatus that is capable of creating a curved edge of various curvatures for the cut material.

A further object of the present invention is to provide a cutting apparatus that is capable of creating both linear and curved edges for the cut material.

In accordance with an aspect of the present invention, there is provided a cutting apparatus for providing a flat material with a curved edge. The cutting apparatus includes a main body, a center member and an arm. The center member is mounted to the main body. The arm engages with the center member and has a cutting part thereon. The cutting part cuts the flat material to have the curved edge by rotating the arm about the center member. Preferably, the cutting apparatus is a trimmer.

For example, the flat material is paper or fabric or plastic. Preferably, the flat material is paper.

In an embodiment, the center member engages with the arm by a screw. The cutting part, e.g. a blade, is removably mounted on the arm so that a position of said cutting part on the arm is changeable to change a size of said curved edge. Alternatively, the center member may movably engage with a rack of the arm so that a distance between the cutting part and the center member is adjustable to change a size of the curved edge.

Preferably, the arm is rotated by manipulating the center member.

In accordance with another aspect of the present invention, there is provided a cutting apparatus for providing a flat material with an edge with a required curvature. The cutting apparatus includes a main body, a securing member, a center member and an arm. The securing member fixes the flat material on the main body. The center member is mounted to the main body. The arm engages with the center member at a first position thereof, and has a cutting part at a second position thereof. The distance between the center member and the cutting part is adjustable according to the required curvature, and the cutting part cuts the flat material to have the edge by rotating the arm about the center member.

Preferably, the securing member is a rail. The main body engages with and travels along the rail to cut a certain portion of the flat material.

In an embodiment, the center member securely engages with the arm at the first position, and the distance between the center member and the cutting part is adjusted by detaching the cutting part from the second position and re-attaching the cutting part to the arm at a third position.

In another embodiment, the cutting part is secured to the arm at the second position, the center member movably engages with a rack of the arm, and the distance between the center member and the cutting part is adjusted by having the center member moved in the rack to a fourth position of the arm.

Preferably, the arm is rotated to move across the flat material by rotating the center member.

In accordance with a further aspect of the present invention, there is provided a cutting apparatus for providing a flat material with an optional linear and/or curved edge. The cutting apparatus includes a main body, a passage, a center member and an arm. The main body has a rail thereon. The passage is for receiving the flat material into the main body therefrom. The center member is mounted to the main body and movable along the rail. The center member has a first cutting part thereon for cutting the flat material to have a linear edge while moving along the rail. The arm engages with the center member, and has a second cutting part thereon for cutting the flat material to have a curved edge while the arm is rotating about the center member.

The rail may have a straight or a wave-shaped slit for the center member to slide therein.

### BRIEF DESCRIPTION OF THE DRAWINGS

FIG. 1 is a perspective view of a conventional cutting apparatus.

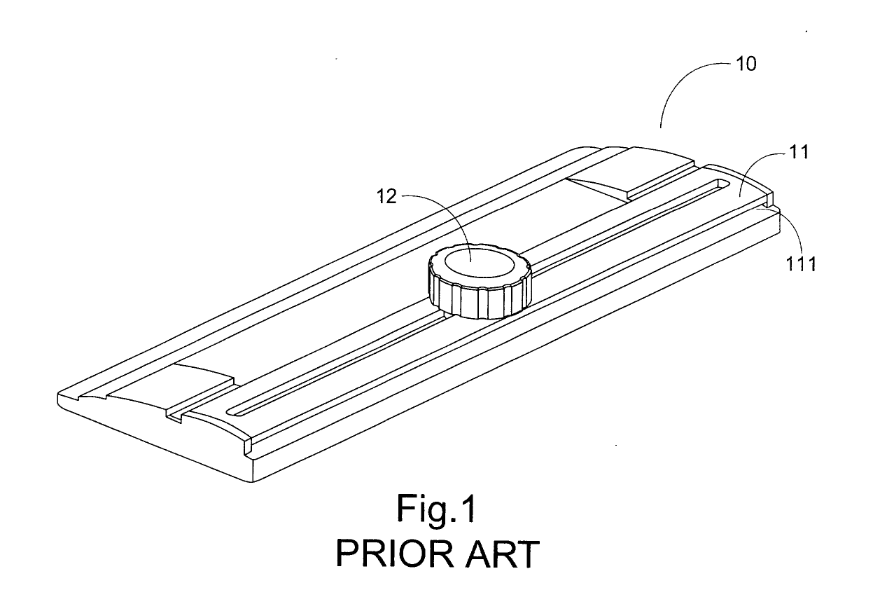

FIGS. 2(a) and 2(b) are a bottom and a front views illustrating the slider of the cutting apparatus of FIG. 1.

FIG. 3 is a perspective view illustrating the cutting apparatus according to a preferred embodiment of the present invention.

FIGS. 4(a) and 4(b) are a side and a top views illustrating the engagement of a center member and an arm of the cutting apparatus of FIG. 3.

FIG. 5 is a side view illustrating the engagement of a center member and an arm of the cutting apparatus according to another embodiment of the present invention.

FIG. 6 is a perspective view illustrating the cutting apparatus according to another preferred embodiment of the present invention.

### DETAILED DESCRIPTION OF THE PREFERRED EMBODIMENT

The present invention will now be described more specifically with reference to the following embodiment. It is to be noted that the following description of preferred embodiment of this invention are presented herein for the purpose of illustration and description only ; it is not intended to be exhaustive or to be limited to the precise form disclosed.

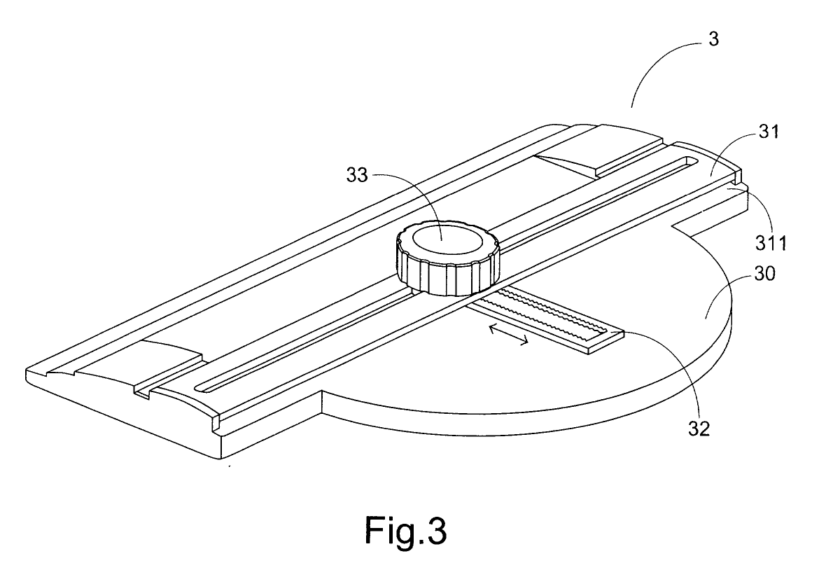

FIG. 3 is a perspective view illustrating the cutting apparatus according to a preferred embodiment of the present invention. The cutting apparatus can provide a flat material with an optional linear and/or curved edge.

The cutting apparatus includes a main body 3, an arm 32 and a center member 33. The main body 3 includes a platform 30 for placing thereon a flat material (not shown) to be cut, and a rail 31 for guiding the center member 33 to move therealong. The flat material enters a passage 311 between the platform 30 and the rail 31, and is secured therein.

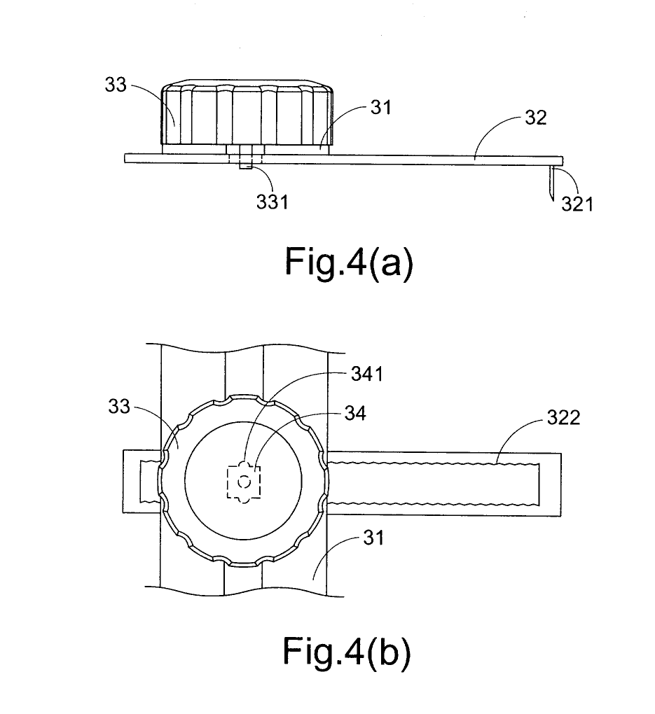

The arm 32 has a blade 321 mounted to the end thereof, as shown in FIG. 4(a). When a curved line is to be provided for the flat material, the center member 33 is turned, and the arm 32 will thus rotate to transmit the blade 321 to cut the flat material to have a curved edge. The size of the curved edge depends on the length of the exposed arm that substantially equals to the radius of the realized circle. The center member 33 engages with the arm 32, but is relatively movable in the rack 322 of the arm 32, as shown in FIG. 4(b). In other words, by pushing or pulling the arm 32 in a direction as indicated by the arrow, the length of the exposed arm is changed. Thereby, the distance between the blade 321 and the center member 33, i.e. the radius, is adjustable, and curved edges of various sizes or curvatures can be obtained.

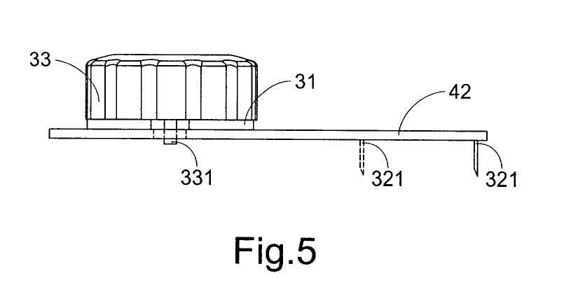

The cutting apparatus of the present invention can cut the flat material with different sizes of the curved edge by moving the arm 32 relative to the center member 33 so as to change the distance between the center member 33 and the blade 321, as mentioned above. In another embodiment with reference to FIG. 5, the blade 321 is detachably mounted on an arm 42 so that the position of the blade 321 on the arm 42 is changeable, and thus the distance between the blade 321 and the center member 33 is adjustable, thereby changing a size of the curved edge. The attachment/detachment of a blade on/from an elongated arm is well known, so it is not to be redundantly described herein.

Please refer to FIG. 4(b) or 5 again. The center member 33 engages with the arm 32 by a screw 331 through a fixing block 34, which is disposed under the rail 31. When the center member 33 is turned, the screw 331 rotates therewith, and serves as a shaft to transmit the arm 32 or 42 and the blade 321 to rotate. The fixing block 34 is used for maintaining the engagement and functions like a washer.

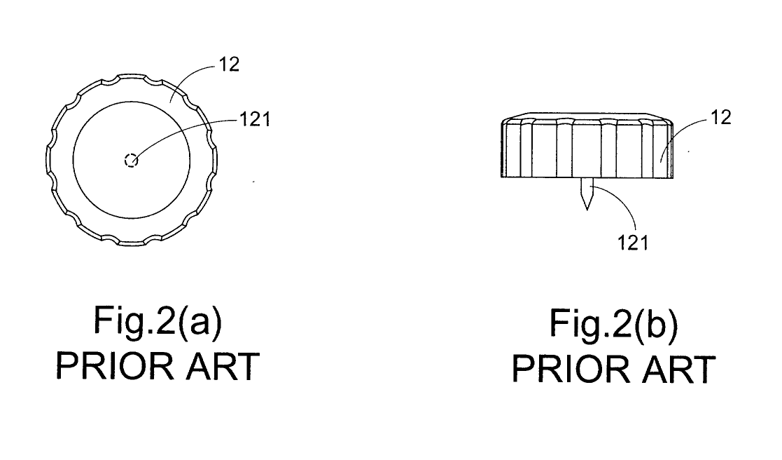

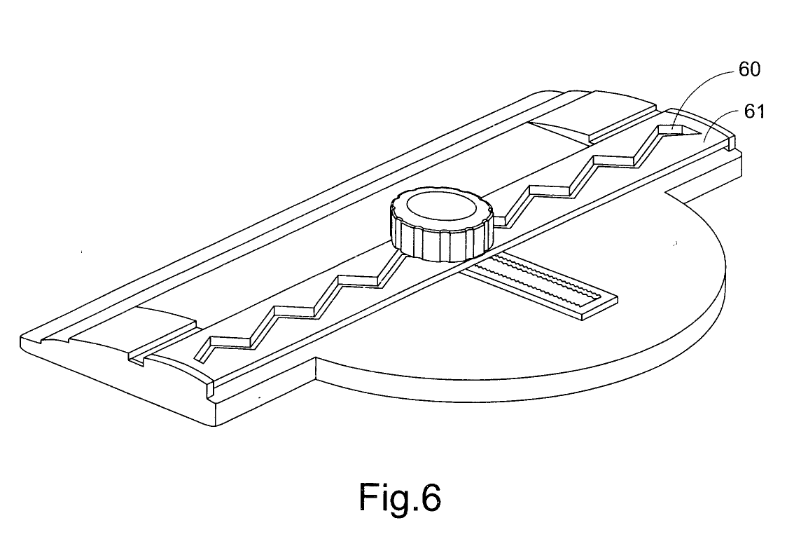

In the embodiments illustrated hereinbefore, the flat material is cut with the blade disposed on the arm. Another blade, however, can be additionally and detachably provided under the center member, as shown in the prior art FIG. 2(a) or 2(b). In this case, a linear line and a curved line can be optionally created by using either of the blades 321 and 121 as the cutting blade. It is to be noted that in addition to a straight line, the linear line can also have some variation. For example, the linear line can be a wave-shaped linear line, as shown in FIG. 6, by arranging a wave-shaped slit 60 in the rail 61.

Certainly, the cutting apparatus of the present invention can be applied to cut several kinds of flat materials. For example, the flat material is made of paper, fabric or plastic. Preferably, the cutting apparatus is used as a trimmer to cut paper. Apparently, the cutting apparatus of the present invention is capable of not only creating linear edges for flat material as the conventional cutting apparatus, but also imparting curved edges to flat material. Consequently, the cutting apparatus will help a lot in daily lives, and will be popular in the market.

While the invention has been described in terms of what is presently considered to be the most practical and preferred embodiment, it is to be understood that the invention needs not be limited to the disclosed embodiment. On the contrary, it is intended to cover various modifications and similar arrangement included within the spirit and scope of the appended claims that are to be accorded with the broadest interpretation so as to encompass all such modification and similar structures.

What is claimed is:

1. A cutting apparatus for providing a flat material with a curved edge, comprising:
a main body;
a center member mounted to said main body; and
an arm engaging with said center member, and having a cutting part thereon, said cutting part cutting said flat material to have said curved edge by rotating said arm about said center member.

2. The cutting apparatus according to claim 1 wherein said cutting apparatus is a trimmer.

3. The cutting apparatus according to claim 1 wherein said flat material is paper.

4. The cutting apparatus according to claim 1 wherein said flat material is fabric.

5. The cutting apparatus according to claim 1 wherein said flat material is plastic.

6. The cutting apparatus according to claim 1 wherein said center member engages with said arm by a screw.

7. The cutting apparatus according to claim 1 wherein said cutting part is removably mounted on said arm so that a position of said cutting part on said arm is changeable to change a size of said curved edge.

8. The cutting apparatus according to claim 1 wherein said center member movably engages with a rack of said arm so that a distance between said cutting part and said center member is adjustable to change a size of said curved edge.

9. The cutting apparatus according to claim 1 wherein said arm is rotated by manipulating said center member.

10. The cutting apparatus according to claim 1 wherein said cutting part is a blade.

11. A cutting apparatus for providing a flat material with an edge with a required curvature, comprising:
a main body;
a securing member for fixing said flat material on said main body;
a center member mounted to said main body; and
an arm engaging with said center member at a first position thereof, and having a cutting part at a second position thereof, wherein a distance between said center member and said cutting part is adjustable according to said required curvature, and said cutting part cuts said flat material to have said edge by rotating said arm about said center member.

12. The cutting apparatus according to claim 11 wherein said securing member is a rail.

13. The cutting apparatus according to claim 11 wherein said main body engages with and travels along said rail to cut a certain portion of said flat material.

14. The cutting apparatus according to claim 11 wherein said center member securely engages with said arm at said first position, and said distance between said center member and said cutting part is adjusted by detaching said cutting part from said second position and re-attaching said cutting part to said arm at a third position.

15. The cutting apparatus according to claim 11 wherein said cutting part is secured to said arm at said second position, said center member movably engages with a rack of said arm, and said distance between said center member and said cutting part is adjusted by having said center member moved in said rack to a fourth position of said arm.

16. The cutting apparatus according to claim 11 wherein said arm is rotated to move across said flat material by rotating said center member.

17. A cutting apparatus for providing a flat material with an optional linear and/or curved edge, comprising:
a main body having a rail thereon;
a passage for receiving said flat material into said main body therefrom;
a center member mounted to said main body and movable along said rail, said center member having a first cutting part thereon for cutting said flat material to have a linear edge while moving along said rail; and
an arm engaging with said center member, and having a second cutting part thereon for cutting said flat material to have a curved edge while said arm is rotating about said center member.

18. The cutting apparatus according to claim 17 wherein said rail has a straight slit therein.

19. The cutting apparatus according to claim 17 wherein said rail has a wave-shaped slit.
